(19) United States
(12) Patent Application Publication
(10) Pub. No.: US 2010/0188697 A1
(43) Pub. Date: Jul. 29, 2010

(54) IMAGE FORMING APPARATUS AND DISPLAY METHOD USING OPERATION DISPLAY PORTION THEREOF

(75) Inventors: Tetsuya MAEDA, Osaka (JP); Yasuhiro Sekiguchi, Osaka (JP)

Correspondence Address: SMITH, GAMBRELL & RUSSELL, 1130 CONNECTICUT AVENUE, N.W., SUITE 1130, WASHINGTON, DC, 20036, US

(73) Assignee: KYOCERA MITA CORPORATION, Osaka (JP)

(21) Appl. No.: 12/692,236

(22) Filed: Jan. 22, 2010

(30) Foreign Application Priority Data
Jan. 26, 2009 (JP) 2009-013791
Jan. 26, 2009 (JP) 2009-013793

(51) Int. Cl. G06F 15/00

(52) U.S. Cl. 358/1.15

(57) ABSTRACT

An image forming apparatus includes: a communication portion; an operation display portion that displays at least an address book screen on which a plurality of first input keys for narrowing transmission destination information are displayed, on which the first input key is operated such that a plurality of second input keys for further narrowing the transmission destination information are displayed and on which the displayed second input key is operated such that the transmission destination information is narrowed and the resulting information is displayed along with names; a display control portion that controls a display on the operation display portion; a key operation detection portion that detects a key operation on the input keys including the first input keys and the second input keys; and a storage portion that stores a plurality of pieces of transmission destination information displayed on the address book screen such that the plurality of pieces of transmission destination information correspond to names, respectively.

This application is based on and claims the benefit of priority from the corresponding Japanese Patent Application Nos. 2009-013791 and 2009-013793 filed on Jan. 26, 2009, the contents of which are hereby incorporated by reference.

### BACKGROUND OF THE INVENTION

1. Field of the Invention

The present invention relates to an image forming apparatus such as a multifunction machine, a copying machine, a printer or a facsimile, and more particularly to an image forming apparatus that has a transmission function.

2. Description of Related Art

In recent years, image forming apparatuses (multifunction machines) having functions such as a scanner function, a printer function, a copying machine function and a facsimile function have been widely used. These image forming apparatuses have not only the function of forming an image but also the function of transmitting various types of data through a telephone line, a network or the like.

In this type of image forming apparatus, a transmission-destination organizing system including a so-called address book is provided so that destinations to which data are transmitted are organized. The transmission destination is set by specifying transmission destination information displayed in the address book. In the image forming apparatus described above, there is generally provided a display portion that has a touch panel function. On the screen of the display portion, the address book screen is displayed.

Moreover, there are conventionally known image forming apparatuses that can enhance user's operability when a transmission destination is specified from an address book. For example, an image forming apparatus is disclosed that has the function of transmitting data by a plurality of transmission methods and that displays, in an address book (address book screen) from which a transmission destination is specified, not only text information indicating the transmission destination but also an icon indicating categories used for specifying which one of the transmission methods is used for the transmission to the transmission destination. In this image forming apparatus, as described above, the text information indicating the transmission destination is displayed along with the icon, and thus it is possible for the user to easily recognize the category of the transmission method. It is therefore possible to reduce the occurrence of an erroneous operation to enhance the user's operability.

In the conventional image forming apparatus described above, it is easy to recognize the category, but it is difficult to enhance the searchability of the transmission destination. Disadvantageously, this complicates an operation of searching for the desired transmission destination from a large number of transmission destinations stored (registered) in the address book. In particular, in recent years, devices that can store thousands of transmission destinations (for example, more than 2000 destinations) in an address book due to increased memory capacity have not been uncommon; in this type of device, the operation of searching for the desired transmission destination is more complicated.

### SUMMARY OF THE INVENTION

In view of the foregoing problem of the conventional technology, the present invention has an object to enhance the operability of an operation of searching for a transmission destination in an image forming apparatus.

To achieve the above object, according to the invention, there is provided an image forming apparatus including: a communication portion for transmitting data; an operation display portion that displays a plurality of input keys on a screen, that receives an instruction through a key operation and that displays at least an address book screen on which a plurality of first input keys for narrowing transmission destination information are displayed, on which the first input key is operated such that a plurality of second input keys for further narrowing the transmission destination information are displayed, on which the displayed second input keys is operated such that the transmission destination information is narrowed and on which to specify a transmission destination displayed along with a name; a display control portion that controls a display on the operation display portion; a key operation detection portion that detects a key operation on the input keys including the first input keys and the second input keys; and a storage portion that stores a plurality of pieces of transmission destination information displayed on the address book screen such that the plurality of pieces of transmission destination information correspond to names, respectively.

Thus, it is possible to further narrow the transmission destination information by operating the second input key after the operation of the first input key. This makes it possible to narrow the transmission destination information with more detailed conditions, and enhance the operability of the operation of searching for the transmission destination information. Hence, even when the number of transmission destinations that can be stored in the address book is increased due to increased memory capacity, it is possible to enhance the searchability of the transmission destination information.

Further features and advantages of the present invention will become apparent from the following description of the embodiment.

### BRIEF DESCRIPTION OF THE DRAWINGS

FIG. 1 is a block diagram showing an example of a schematic configuration of a multifunction machine of an embodiment;

FIG. 2 is a plan view showing an example of an operation panel in the multifunction machine of the embodiment;

FIG. 3 is a diagram showing an example of an address book screen of the multifunction machine of the embodiment;

FIG. 4 is a diagram showing an example of a transmission destination registration screen of the multifunction machine of the embodiment;

FIG. 5 is a diagram showing an example of the display change of a narrowing key on the address book screen of the embodiment;

FIG. 6 is a diagram showing an example of an initial setting screen on which to perform initial settings on transmission destination information displayed on the address book screen of the embodiment;

FIG. 7 is a flowchart showing an example of an operation of setting a transmission destination in the multifunction machine of the embodiment;

FIG. 8 is a diagram showing the example of the operation of setting the transmission destination in the multifunction machine of the embodiment;

FIG. 9 is a diagram showing the example of the operation of setting the transmission destination in the multifunction machine of the embodiment;

FIGS. 10A to 10J are diagrams showing the example of the operation of setting the transmission destination in the multifunction machine of the embodiment;

FIG. 11 is a flowchart showing an example of an operation of changing a narrowing condition in the multifunction machine of the embodiment:

FIG. 12 is a flowchart showing an example of an operation of selecting the type of transmission destination information displayed on an operation display portion of the embodiment;

FIG. 13 is a diagram showing the example of the operation of selecting the type of transmission destination information displayed on the operation display portion of the embodiment; and

FIG. 14 is a diagram showing the example of the operation of selecting the type of transmission destination information displayed on the operation display portion of the embodiment.

### DETAILED DESCRIPTION OF PREFERRED EMBODIMENTS

An embodiment embodying the present invention will be described in detail below with reference to the accompanying drawings. In the following embodiment, a description is given of an example of a case where the present invention is applied to a multifunction machine 1, which is an example of an image forming apparatus.

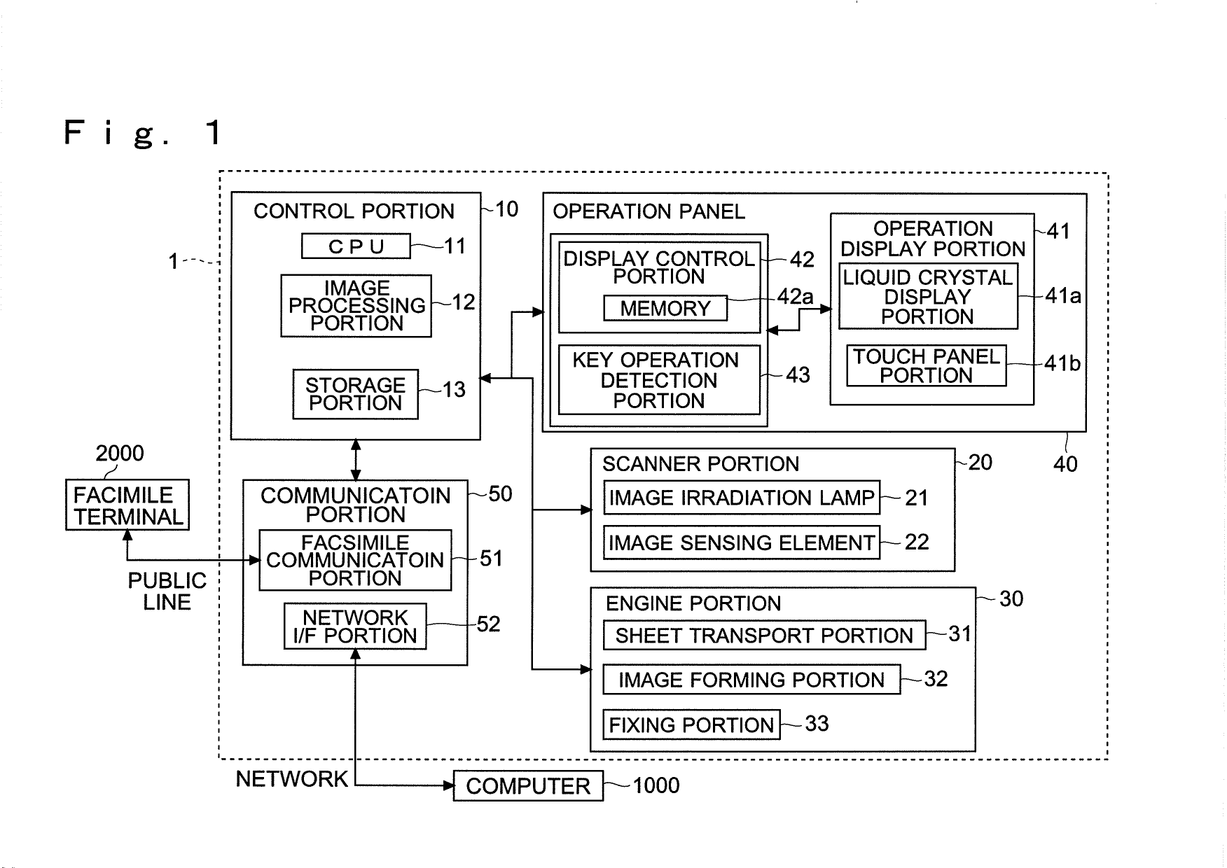

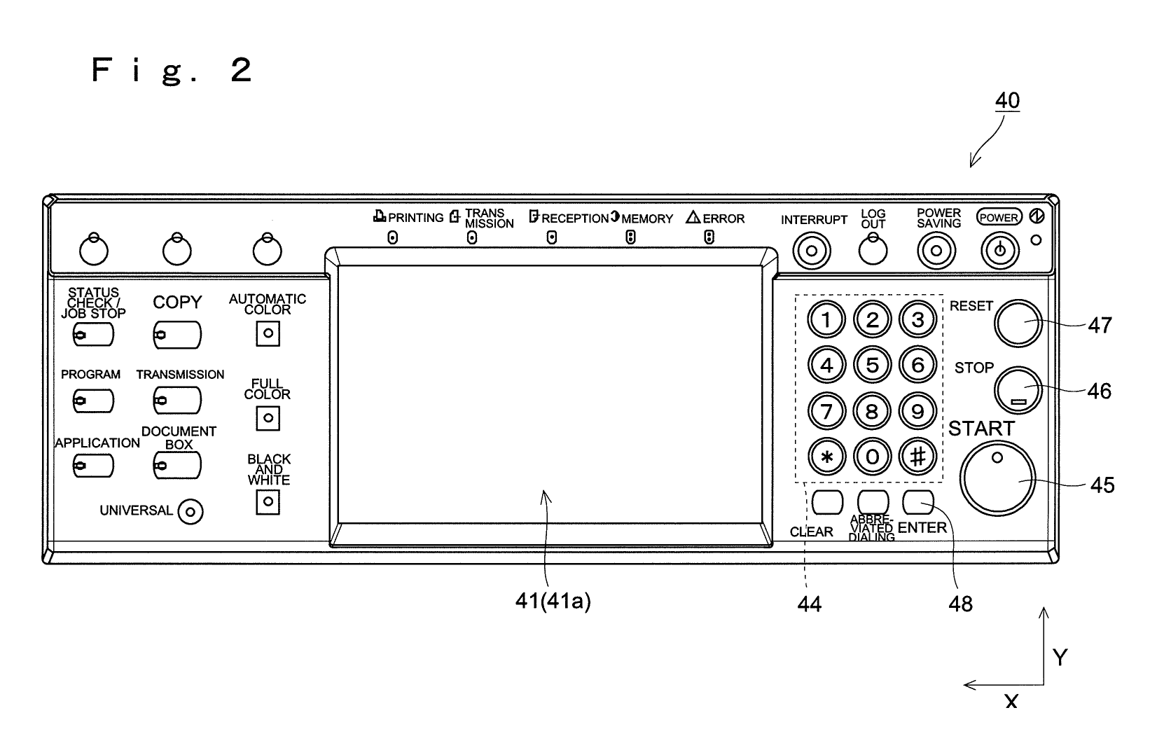

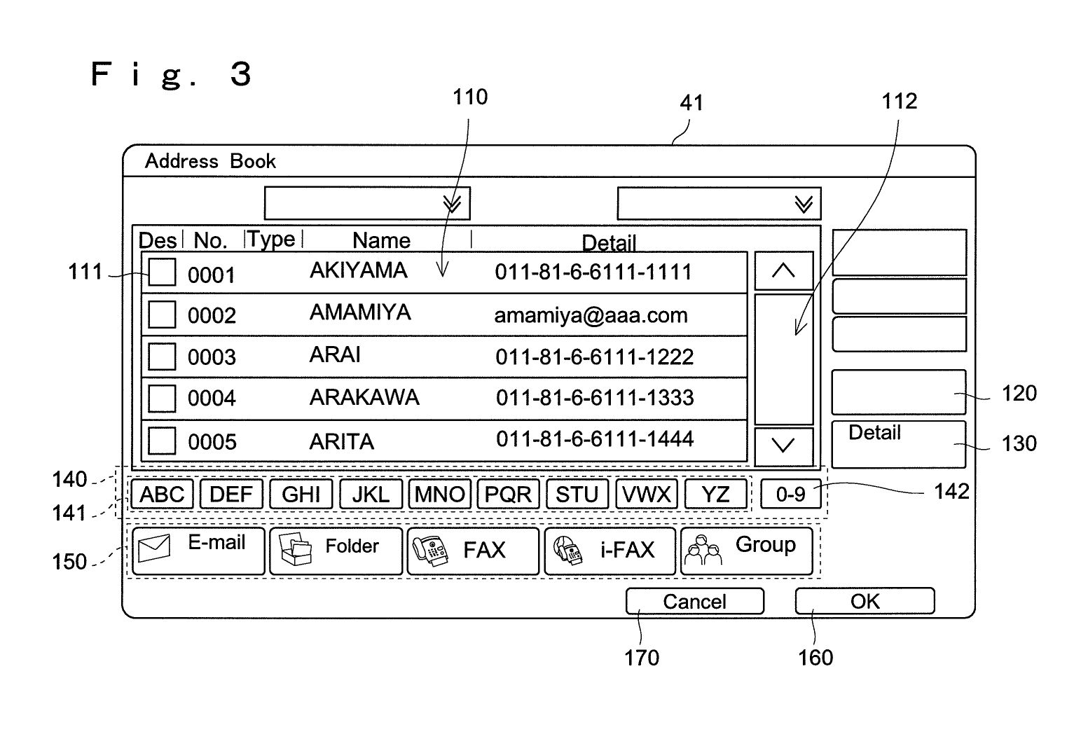

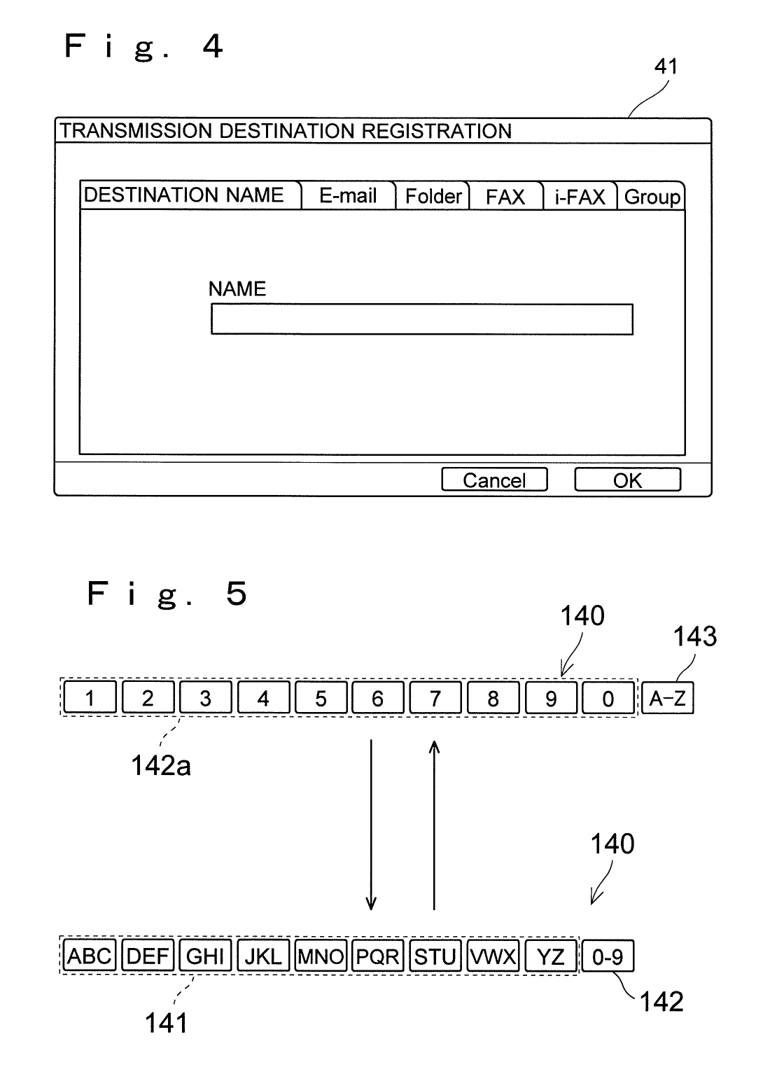

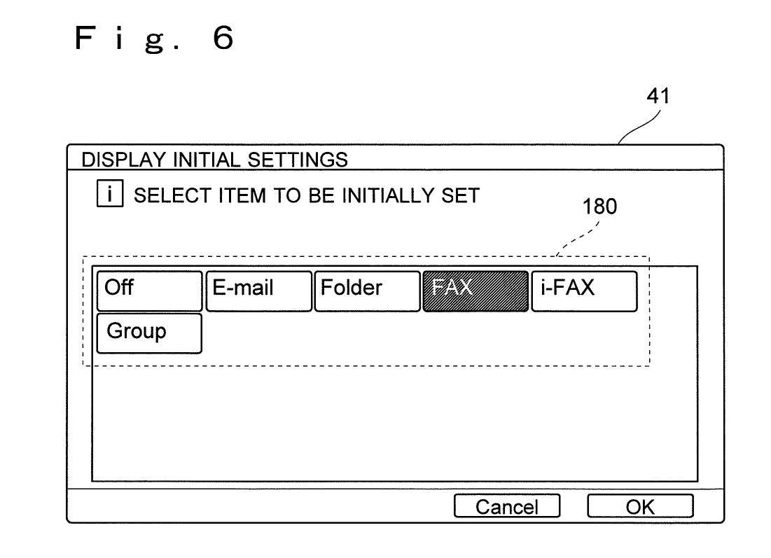

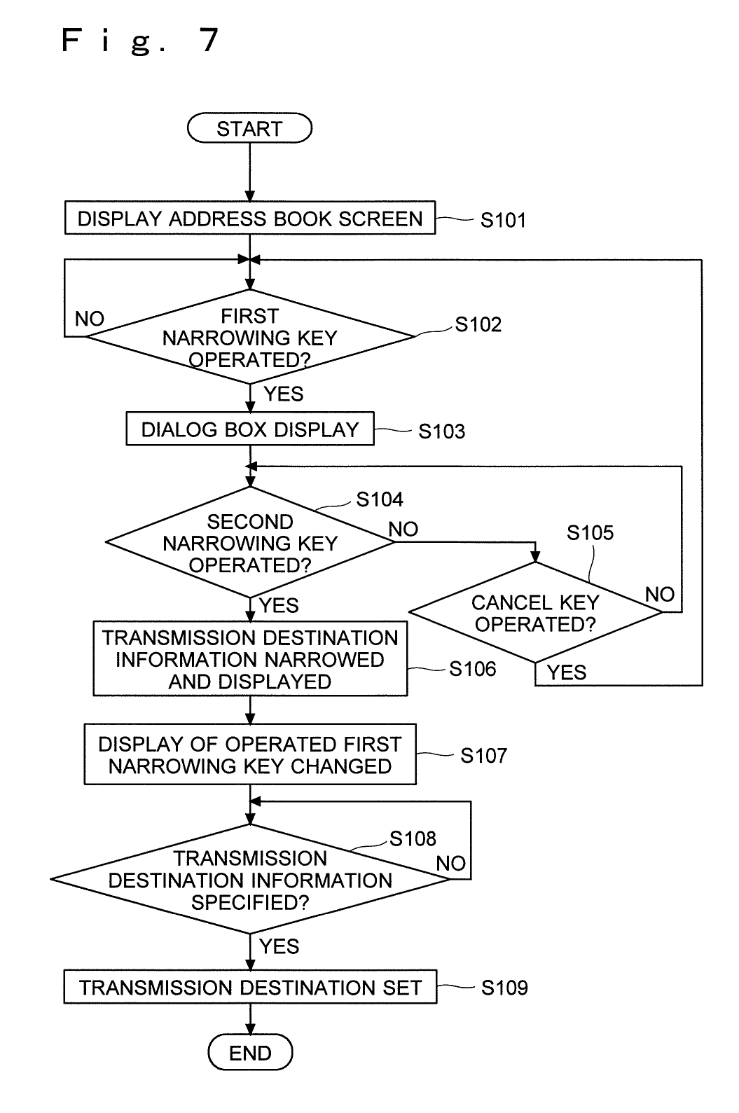

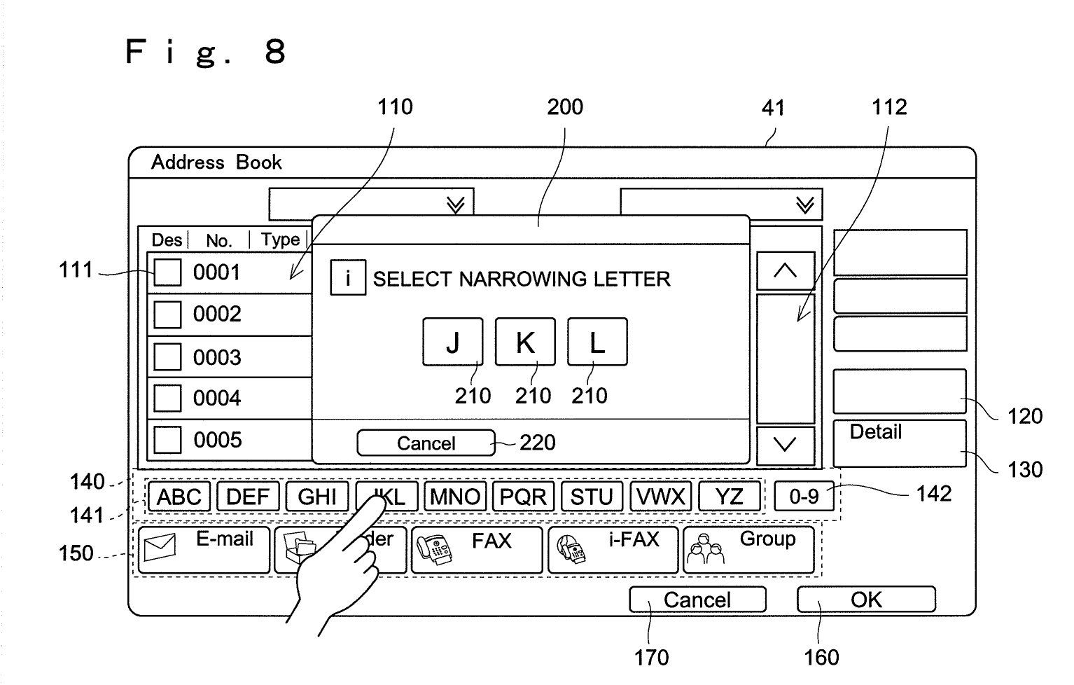

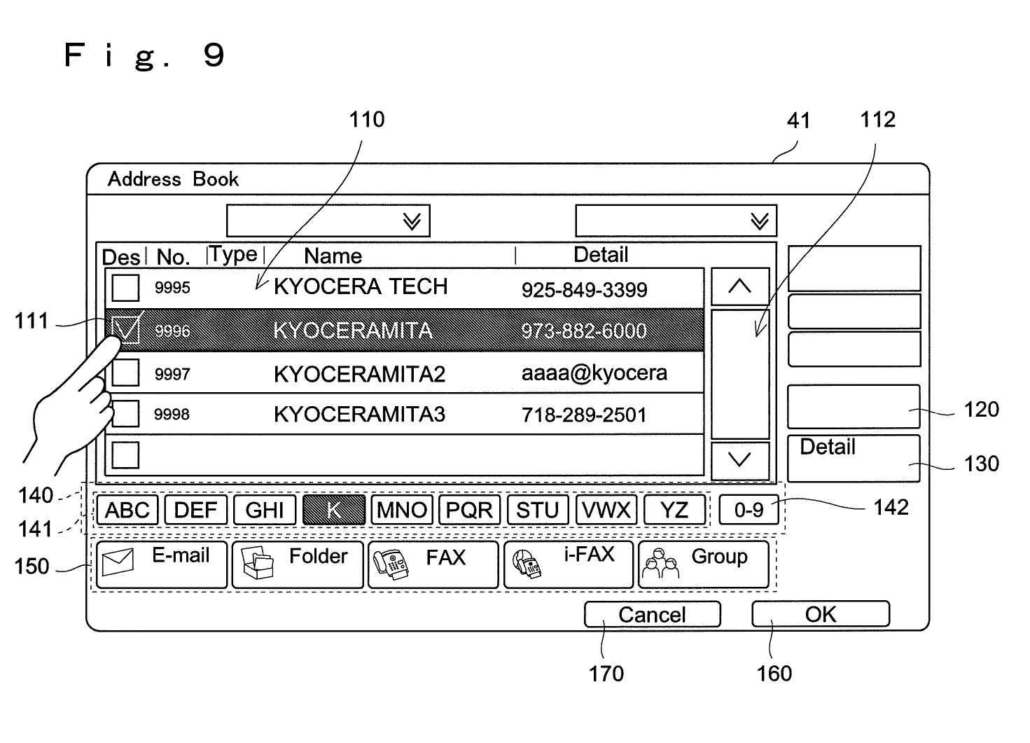

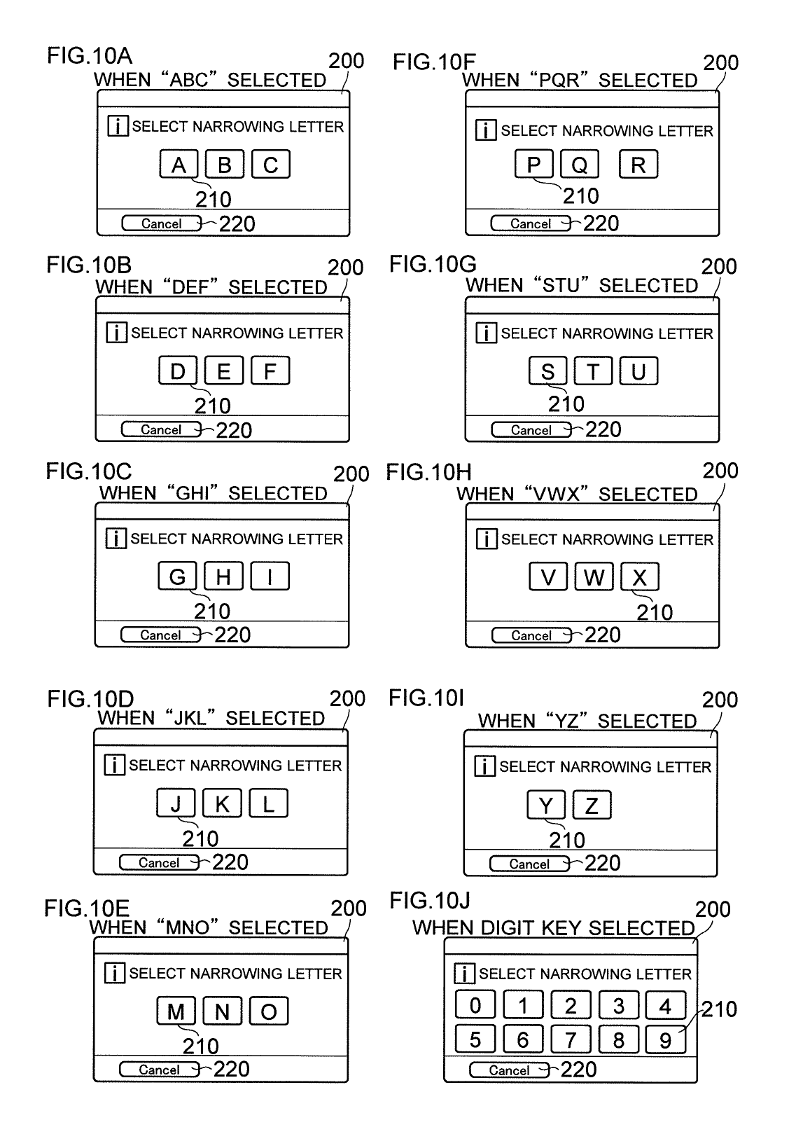

FIG. 1 is a block diagram showing an example of a schematic configuration of the multifunction machine 1 of the embodiment of the present invention. FIG. 2 is a plan view showing an example of an operation panel 40 in the multifunction machine 1 of the embodiment of the invention.

(The Schematic Configuration of the Image Forming Apparatus)

The multifunction machine 1 according to the embodiment of the invention will first be schematically described with reference to FIG. 1. The multifunction machine 1 of this embodiment is a network-compatible digital multifunction machine 1 that has functions such as a scanner function, a printer function, a copying machine function and a facsimile function. The multifunction machine 1 has the function of transmitting data by a plurality of transmission methods.

In the multifunction machine 1 of this embodiment, as shown in FIG. 1, its overall operation is controlled by a control portion 10. The multifunction machine 1 has, as devices connected to this control portion 10 and provided with various functions, a scanner portion 20, an engine portion 30, an operation panel 40 and a communication portion 50.

The control portion 10 includes a CPU 11, an image processing portion 12 and a storage portion 13. The CPU 11 is a central processing unit and controls individual portions of the multifunction machine 1 based on a control program that is stored in the storage portion 13 and that is retrieved therefrom. The image processing portion 12 performs various types of image processing on: image data read by the scanner portion 20; image data for printing; and image data that is transmitted to a computer 1000 (for example, an information processing device such as a personal computer) and to a facsimile terminal 2000 of a party on the other end of the line. The storage portion 13 is configured by combining nonvolatile and volatile storage devices such as a ROM (read only memory), a RAM (random access memory) and a I-IDD (hard disk drive). In this storage portion 13, various types of data are stored such as a program for controlling the multifunction machine 1, control data, setting data and image data. The storage portion 13 can also store destination names and transmission destination information corresponding to the destination names.

The scanner portion 20 includes an image irradiation lamp 21 and an image sensing element 22 (for example, a CCD (charge coupled device) image sensor); these constitute a scanner. In the scanner portion 20, light is shone on an original document by the image irradiation lamp 21, and the light reflected therefrom is received by the image sensing element 22, with the result that an image is read from the original document. Then, the scanner portion 20 outputs, to the image processing portion 12, image data corresponding to the read image.

The engine portion 30 includes a sheet transport portion 31, an image forming portion 32 and a fixing portion 33. The sheet transport portion 31 has a sheet feed cassette, a sheet feed roller and the like, which are not shown in the figure, and transports a sheet of paper. The image forming portion 32 forms an image on the sheet of paper based on image data (a printer head, a photoconductive drum and the like). The fixing portion 33 applies heat to the image obtained by the image forming portion 32 to fix the image. The engine portion 30 uses the image data read by the scanner portion 20, image data obtained through the communication portion 50 and the like to print the image on the sheet of paper.

(The Operation Panel 40)

The operation panel 40 according to the embodiment of the invention will now be described with reference to FIGS. 1 and 2. FIG. 2 is the plan view showing the example of the operation panel in the multifunction machine 1 of the embodiment.

The operation panel 40 includes: an operation display portion 41 that displays imaginary keys (input keys) on the screen and that receives the operation of the key and thus selectively operates various functions; a display control portion 42 that controls a display produced by the operation display portion 41; and a key operation detection portion 43 that detects and determines the operation of the input key displayed on the screen. The operation display portion 41 has: a liquid crystal display portion 41a that displays items to be processed and the input keys; and a touch panel portion 41b that is placed on top of the liquid crystal display portion 41a and that detects a position touched by a finger of a user or the like.

The display control portion 42 includes a CPU, an IC and other electronic elements, and controls the display produced by the liquid crystal display portion 41a. The key operation detection portion 43 detects, based on the position detected by the touch panel portion 41b, whether or not the input key displayed on the screen is operated by the user. The display control portion 42 and the key operation detection portion 43 are controlled by, for example, instructions from the CPU 11. For example, processing (operation) by the operation display portion 41 is performed based on the control program stored in the storage portion 13. The control program for the operation display portion 41 and the key operation detection portion 43 may be stored in a memory 42a within the display control portion 42.

The communication portion 50 includes a facsimile communication portion 51 and a network I/F portion 52. The facsimile communication portion 51 transmits, through a public line, the image data of the original document read by the scanner portion 20 and other data to the facsimile terminal 2000 of the party on the other end of the line or the like, and receives image data transmitted from the facsimile terminal 2000 and the like. The network I/F portion 52 controls the exchange of various data with a plurality of computers 1000 that are connected through a network (for example, the Internet or a LAN (local area network)). As described above, the multifunction machine 1 of this embodiment has the function of transmitting data by a plurality of transmission methods.

As shown in FIG. 2, the liquid crystal display portion 41a (operation display portion 41) is arranged substantially in the center of the operation panel 40. This liquid crystal display portion 41a (operation display portion 41) has a screen size of eight inches (800 pixels in the x-direction and 480 pixels in the y-direction), and can produce a color display. Around the operation display portion 41, there are provided: a numerical keypad 44 for receiving digits; a start key 45 for receiving instructions to start various operations (for example, a facsimile transmission operation, a copying operation and a data transmission operation); a stop key 46 for receiving instructions to stop various operations; a reset key 47 for receiving instructions to reset various settings; an enter key 48; and the like. The pressing of the enter key 48 is similar in function to the giving of an instruction to provide “OK” in operations on the screen of the operation display portion 41

(Address Book Screen)

An address book screen displayed on the operation panel 40 of the embodiment of the invention will now be described with reference to FIGS. 3 to 6. FIG. 3 is a diagram showing an example of the address book screen of the multifunction machine 1 of the embodiment. FIG. 4 is a diagram showing an example of a transmission destination registration screen of the multifunction machine 1 of the embodiment. FIG. 5 is a diagram showing an example of the display change of a narrowing key on the address book screen of the embodiment. FIG. 6 is a diagram showing an example of an initial setting screen on which to perform initial settings on the transmission destination information displayed on the address book screen of the embodiment.

The multifunction machine 1 has an address book function (transmission-destination organizing system) for organizing destinations to which data is transmitted. In this address book function, the address book screen as shown in FIG. 3 is displayed on the screen of the operation display portion 41. Specifically, the operation display portion 41 displays in a list form, on the address book screen, the names of transmission destinations and the transmission destination information (such as transmission destination addresses) that are previously registered (previously stored in the storage portion 13). Then, the user specifies the desired transmission destination information from the transmission destination information displayed in a list form to set the transmission destination.

In the address book screen displayed on the screen of the operation display portion 41, there are arranged: a transmission destination display region 110 in which the transmission destination information is displayed in a list form; a registration screen fetch key 120 for fetching (displaying) a screen on which the transmission destination information is registered and changed; a detail key 130 for displaying detailed information; a narrowing key 140 for narrowing the transmission destination information with the initial letter of the corresponding name (destination name); selection keys 150 for selecting the type of transmission method of the transmission destination information; an OK key 160; a cancel key 170; and the like.

In the transmission destination display region 110, the transmission destination information is displayed along with names (destination names). In the left side of the transmission destination display region 110, there are arranged check boxes 111 for specifying the transmission destination information. In the right side of the transmission destination display region 110, there is arranged a scroll bar 112 for vertically scrolling the transmission destination information.

When the user operates (presses down) the registration screen fetch key 120, the transmission destination registration screen as shown in FIG. 4 is displayed on the operation display portion 41 (see FIG. 2). For example, when a blank portion is pressed down, an input keyboard (not shown) is displayed. With this input keyboard, it is possible to enter letters and digits. Through this screen, not only the names of the transmission destinations but also the transmission destinations (destinations) including the transmission destination information are registered, and the transmission destination information is made correspond to the names and stored in the storage portion 13 (see FIG. 1) (The pressing down and thus selecting of a tab makes it possible to register e-mail addresses, facsimile terminal addresses and the like.) In the multifunction machine 1 of this embodiment, the number of transmission destinations registered in the address book is about 2000 in names (destination names).

In the multifunction machine 1 of this embodiment, for each name (destination name), a plurality of types of transmission destination information corresponding to a plurality of (for example, five) transmission methods can be registered (stored in the storage portion 13). Specifically, in the multifunction machine 1, for each name (destination name), five transmission destination addresses (transmission destination information), namely, a facsimile terminal address (fax number), a network facsimile terminal address, an e-mail address, a SMB (server message block) folder address and a FTP (file transfer protocol) folder address, can be registered. The facsimile terminal address can be registered by using a “FAX” tab screen. The network facsimile terminal address can be registered by using an “i-FAX” tab screen. The e-mail address can be registered by using an “E-mail” tab screen. The SMB folder address and the FTP folder address can be registered by using “Folder” and “Group” tab screens, respectively. The “Folder” and “Group” can be hierarchized.

When the detail key 130 shown in FIG. 3 is operated by the user, the detailed information of the selected transmission destinations is displayed on the operation display portion 41.

As shown in FIG. 3, the narrowing key 140 is composed of a plurality of input key groups including: first narrowing keys 141 on which the letters of the alphabet are grouped and displayed; and a digit key 142. The first narrowing keys 141 are an example of “first input keys” of the present invention. As shown in FIG. 5, when the user operates the digit key 142, the narrowing key 140 is changed such that the digit key 142 is developed into ten input keys 142a on which digits from 1 to 0 are displayed. Here, a plurality of first narrowing keys 141 are stored in an alphabet key 143. On the other hand, when the user operates the alphabet key 143, the alphabet key 143 is developed into a plurality of (nine) first narrowing keys 141.

As shown in FIG. 3, the selection keys 150 are five input key groups that are assigned to the individual types of transmission methods, respectively. Specifically, different transmission methods, namely, the “E-mail”, the “Folder”, the “FAX”, the “i-FAX” and the “Group” are assigned to the individual selection keys 150, respectively. When the user operates the selection key 150, the transmission destination information (transmission destination addresses) on the transmission method assigned to the operated selection key 150 is only displayed on the address book screen, (and in other words, narrowing is performed). In the multifunction machine 1 of this embodiment, a plurality of selection keys 150 can be selected simultaneously (for example, the “FAX” and the “i-FAX”).

In the multifunction machine 1 of this embodiment, the storage portion 13 (see FIG. 1) can store, as initial settings, the state in which the selection key 150 is operated. Specifically, in the multifunction machine 1, the settings (initial settings) are previously performed, and thus, when the address book screen is displayed (the address book is opened), the transmission destination information for the specific transmission method out of the transmission destination information can only be displayed on the address book screen. In the initial setting screen, there are arranged setting keys 180 corresponding to the selection keys 150. The user operates these setting keys 180 to narrow, with the transmission method assigned to each of the setting keys 180, the transmission destination information displayed in the initial state (when the address book is opened).

In the initial setting screen, a plurality of setting keys 180 are operated, and thus a plurality of transmission methods can be selected (set). Here, the operated setting keys 180 are highlighted. In this way, it is possible for the user to recognize which setting keys 180 are operated. When the setting key 180 of “OFF” is operated, all settings are cancelled. On the other hand, when the setting key 180 that is set (highlighted) is operated again, the setting is cancelled on an individual basis. Here, the display of the setting key 180 is returned to the original state (not highlighted).

(Setting of the Transmission Destination)

An operation of setting the transmission destination in the multifunction machine 1 of this embodiment will now be described with reference to FIGS. 1 to 3 and FIGS. 7 to 10. FIG. 7 is a flowchart showing an example of the operation of setting the transmission destination in the multifunction machine 1 of the embodiment. FIGS. 8 to 10J are diagrams showing the example of the operation of setting the transmission destination in the multifunction machine 1 of the embodiment. The following description deals with a case where narrowing is not performed with the setting key 180.

First, in step S101 of FIG. 7, the address book screen as shown in FIG. 3 is displayed on the screen of the operation display portion 41 (see FIG. 2). Here, in the transmission destination display region 110 of the address book screen, the transmission destination information (all the transmission destination information) registered is displayed from the top in alphabetical order.

Then, whether or not the first narrowing key 141 is operated (pressed down) is determined (step S102). As shown in FIG. 3, when the desired transmission destination (transmission destination information) is not displayed on the address book screen, the desired transmission destination can be searched for by operating the scroll bar 112 to vertically scroll the transmission destinations. However, when a large number of transmission destinations are registered, this operation of searching for the desired transmission destination is complicated. To overcome this, it is possible for the user to operate the first narrowing key 141 to narrow, with the initial letter of the name (destination name), the transmission destinations (transmission destination information) that are displayed on the address book screen. In step S102, whether or not the operation described above is performed is determined.

If the first narrowing key 141 is determined not to be operated (no in step S102), whether or not the first narrowing key 141 is operated is repeatedly determined in step S102. On the other hand, if the first narrowing key 141 is determined to be operated (yes in step S102), the display control portion 42 displays a dialog box 200 on the address book screen (step S103). Specifically, as shown in FIG. 8, the first narrowing key 141 is operated by the user, and thus a plurality of second narrowing keys 210 on which alphabetical letters included in the first narrowing key 141 are displayed are displayed in the dialog box 200. The second narrowing keys 210 are an example of “second input keys” of the present invention.

Then, whether or not the second narrowing key 210 is operated is determined (step S104). If the second narrowing key 210 is determined not to be operated (no in step S104), whether or not a cancel key 220 in the dialog box 200 is operated is determined (step S105). If the cancel key 220 is determined not to be operated (no in step S105), the process returns to step S104, and the determination operation in step S104 is repeated. On the other hand, if the cancel key 220 is determined to be operated (yes in step S105), the process returns to step S102, and the processing in steps S102 to S104 is repeated. In other words, the narrowing processing is not performed, and thus the dialog box 200 is closed. If the second narrowing key 210 is determined to be operated (yes in step S104), the dialog box 200 is closed, and the display control portion 42 displays, on the operation display portion 41, an address book screen obtained by narrowing the transmission destination information (destination names of the transmission destination information) with the letters displayed in the operated second narrowing key 210 (step S106).

The narrowing will now be described. The destination names and the corresponding transmission destination information are stored in the storage portion 13. Then, the operation of the second narrowing key 210 is detected by the key operation detection portion 43. Here, the key operation detection portion 43 can recognize which one of the second narrowing keys 210 displayed in the dialog box 200 is operated. Thus, data indicating the letter or digit displayed in the operated second narrowing key 210 is transmitted from the operation panel 40 (key operation detection portion 43) to the control portion 10.

After receiving this data, for example, the CPU 11 in the control portion 10 extracts, from the transmission destination information stored in the storage portion 13, the transmission destination information on the destination names whose initial letter agrees with the letter displayed on the operated second narrowing key 210. Then, the control portion 10 transmits data including the extracted destination names and transmission destination information to the display control portion 42 in the operation panel 40. The display control portion 42 displays, based on the data including the extracted names and transmission destination information, the names and the transmission destination information on the address book screen. Thus, the transmission destination information is narrowed with the letter or digit displayed on the second narrowing key 210. As described above, the control portion 10 (CPU 11) can be utilized as a narrowing processing portion that narrows the transmission destination information with the initial letter of the name and that outputs the extracted transmission destination information.

All or part of the transmission destination information may be stored in the display control portion 42 (For example, the memory 42a for storing the transmission destination information is provided in the display control portion 42.) Each time the second narrowing key 210 is operated, the display control portion 42 extracts transmission destination information on the destination names whose initial letter agrees with the letter displayed on the second narrowing key 210. Then, the results obtained by the extraction are displayed, as the transmission destination information, on the address book screen along with the names. In this way, the transmission destination information is also narrowed with the letter or digit displayed on the second narrowing key 210. As described above, the display control portion 42 can be utilized as the narrowing processing portion that narrows the transmission destination information with the initial letter of the name and that outputs the extracted transmission destination information.

Specifically, for example, when the initial letter of the name of the desired transmission destination is “K”, and the names (destination names) are desired to be narrowed with the initial letter “K”, as shown in FIG. 8, the user first operates the first narrowing key 141 on which the letters “J, K and L” are displayed. When the first narrowing key 141 is operated, the second narrowing keys 210 on which the letters (“J”, “K” and “L”) belonging to the first narrowing key 141 are displayed are displayed along with the dialog box 200. Here, if the user operates the cancel key 220 in the dialog box 200, the narrowing processing is not operated, and the dialog box 200 is closed. On the other hand, when the second narrowing key 210 on which the letter “K” is displayed is operated, the dialog box 200 is closed. Then, as shown in FIG. 9, the names of transmission destinations (destination names) are narrowed with the initial letter “K”, and transmission destination information obtained by narrowing the information is displayed on the address book screen.

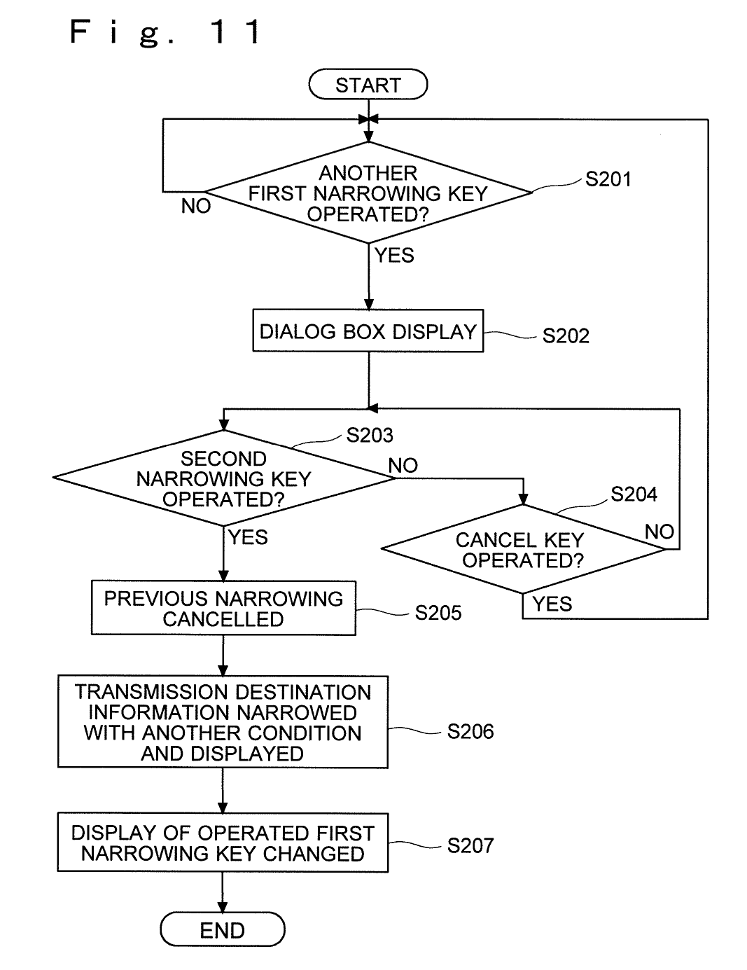

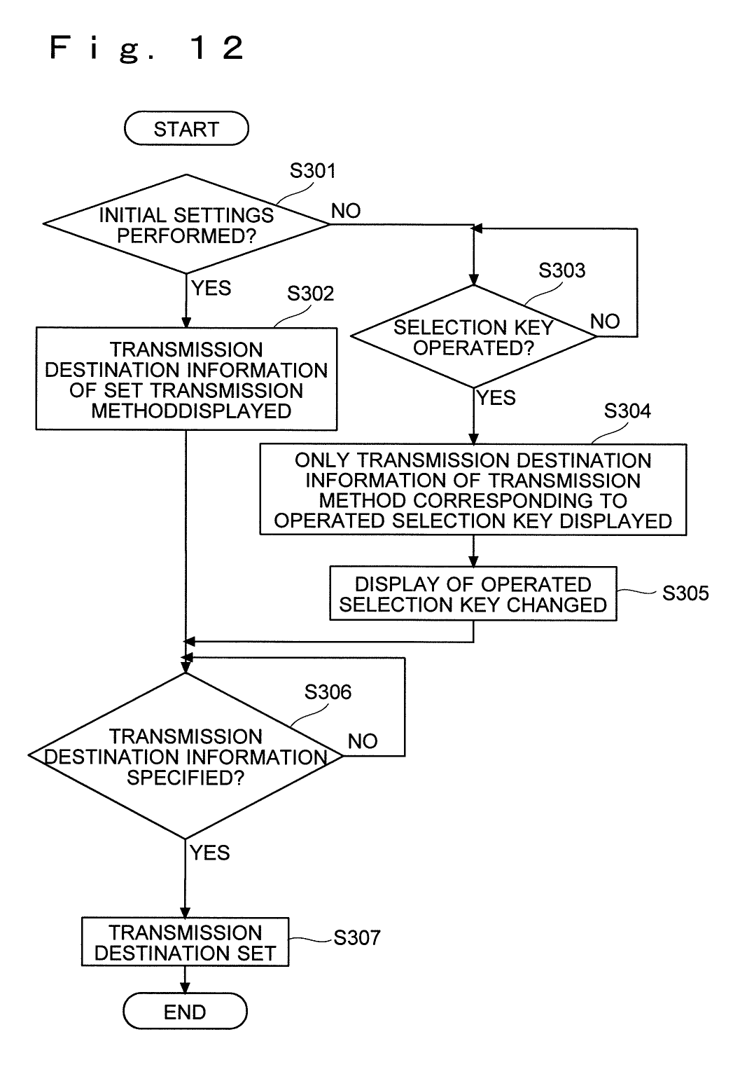

Examples of the second narrowing keys 210 displayed when the first narrowing keys 141 from “A, B and C” to “Y and Z” are individually selected (operated) are shown in FIGS. 10A to 10I. Specifically, when the first narrowing key 141 is operated, the second narrowing keys 210 on which the corresponding alphabetical letters belonging to the first narrowing key 141 are displayed are displayed by the dialog box 200. FIG. 10J shows an example of the second narrowing keys 210 displayed when the digit key 142 is operated.

Then, the process proceeds to step S107 of FIG. 7. The display control portion 42 (see FIG. 1) displays the address book screen in which the display of the operated first narrowing key 141 is changed (step S107). Specifically, as shown in FIG. 9, the operated first narrowing key 141 is highlighted, and the displayed letter is changed to the letter (for example, “K”) displayed on the operated second narrowing key 210 (see FIG. 8). Thus, for example, it is possible for the user to easily recognize that the names of transmission destinations (destination names) are narrowed with the initial letter “K”.

Thereafter, the process proceeds to step S108, where whether or not the transmission destination information (transmission destination) is specified is determined (step S108). As shown in FIG. 9, the transmission destination is specified by pressing down the operation display portion 41 and checking the check box 111. A plurality of transmission destinations can be specified. If the transmission destination is determined not to be specified (no in step S108), whether or not the transmission destination information (transmission destination) is specified is repeatedly determined. On the other hand, if the transmission destination information (transmission destination) is determined to be specified (yes in step S108), the transmission destination is set (step S109). Then, if the OK key 160 (see FIG. 9) on the address book screen is operated, the address book screen is closed. The operation of closing the address book screen can also be performed by operating the enter key 48 (see FIG. 2). Consequently, the operation of setting the transmission destination is completed in the multifunction machine 1 of this embodiment.

When the first narrowing key 141 that is highlighted is operated again, the narrowing is cancelled. The names of transmission destinations are narrowed with the initial letter of names.

(The Change of a Narrowing Condition)

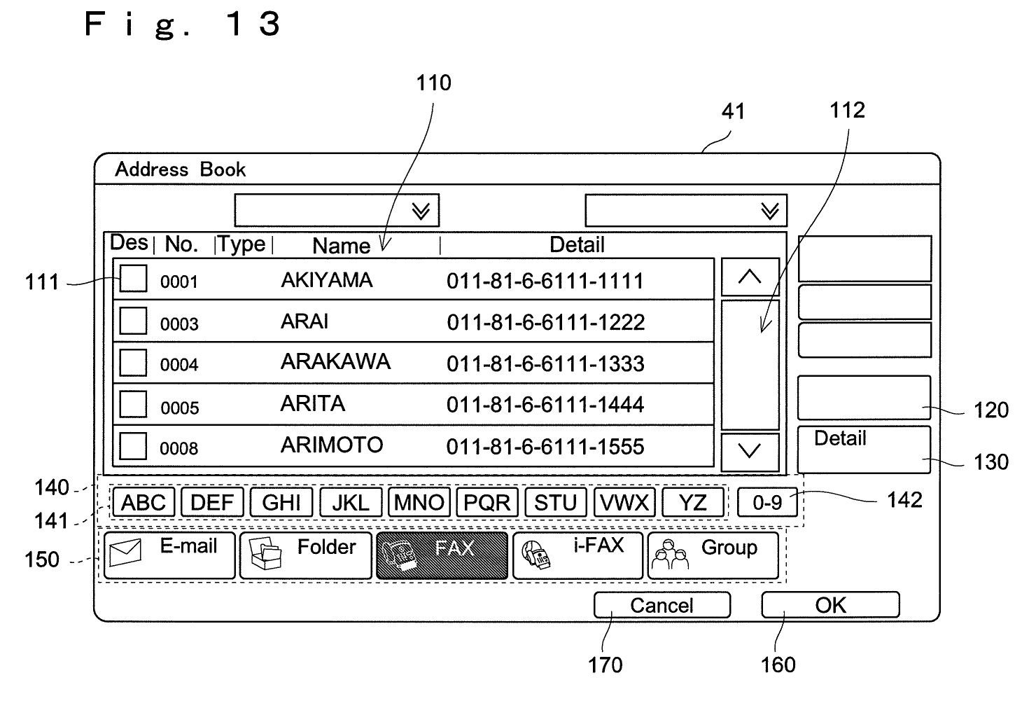

An operation of changing a narrowing condition (a narrowing letter) in the multifunction machine 1 of the embodiment will now be described with reference to FIGS. 1, 7 and 11. FIG. 11 is a flowchart showing an example of the operation of changing the narrowing condition in the multifunction machine 1 of the embodiment. The address book screen that is displayed after the transmission destinations are narrowed with a predetermined alphabetical letter is shown.

Whether or not another first narrowing key 141 is operated is first determined (step S201). If the first narrowing key 141 is determined not to be operated (no in step S201), whether or not the first narrowing key 141 is operated is repeatedly determined in step S201. On the other hand, if the first narrowing key 141 is determined to be operated (yes in step S201), the second narrowing keys 210 corresponding to the operated first narrowing key 141 are displayed on the address book screen by the dialog box 200 (step S202). Then, whether or not the second narrowing key 210 is operated is determined (step S203). If the second narrowing key 210 is determined not to be operated (no in step S203), whether or not the cancel key 220 in the dialog box 200 is operated is determined (step S 204).

If the cancel key 220 is determined not to be operated (no in step S204), the determination in step S203 is repeated. On the other hand, if the cancel key 220 is determined to be operated (yes in step S204), the process returns to step 201, where the processing in steps S201 to S203 is repeated. Specifically, the narrowing processing is not performed under another condition (letter), and the dialog box 200 is closed.

If the second narrowing key 210 is determined to be operated (yes in step S203), the previous narrowing is cancelled (step S205). Then, the transmission destination information (destination names of the transmission destination information) is narrowed under another condition (the letter displayed on the operated second narrowing key 210), and the resulting information is displayed on the address book screen (step S206). The extraction and the like of the transmission destination information by narrowing it may be performed as shown in FIG. 7. The same processing as in step S107 described above and shown in FIG. 7 is finally performed, and the display control portion 42 (see FIG. 1) changes the display of the operated first narrowing key 141, and displays the resulting display on the address book screen (step S207). Consequently, the operation of changing the narrowing condition in the multifunction machine 1 of this embodiment is completed.

(The Selection of the Type of Transmission Destination Information)

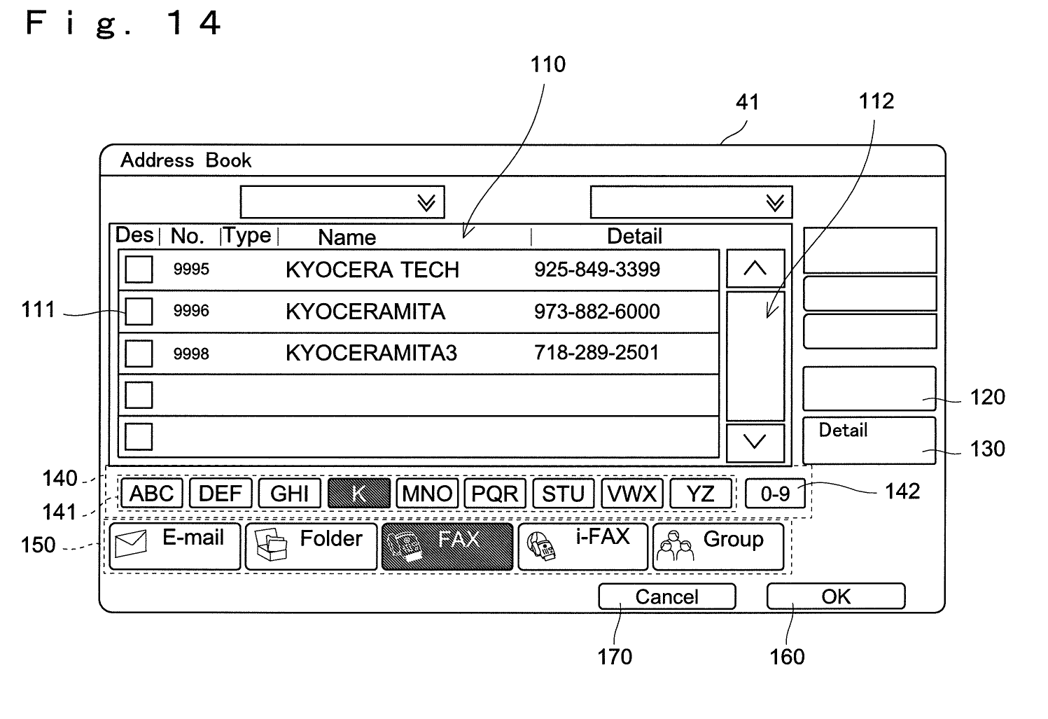

An operation of setting the transmission destination by selecting the type of transmission destination information (transmission destination addresses) displayed on the operation display portion 41 will now be described with reference to FIGS. 3, 6, 7, 9 and 11 to 14. FIG. 12 is a flowchart showing an example of the operation of selecting the type of transmission destination information displayed on the operation display portion 41 of the embodiment. FIG. 13 is a diagram showing the example of the operation of selecting the type of transmission destination information displayed on the operation display portion 41 of the embodiment. FIG. 14 is a diagram showing the example of the operation of selecting the type of transmission destination information displayed on the operation display portion 41 of the embodiment.

Whether or not transmission destination information on a specific transmission method displayed when the address book is opened is set as the initial settings is first determined (step S301). Specifically, whether or not any (two or more) of the setting keys 180, namely, the “E-mail”, the “Folder”, the “FAX”, the “i-FAX” and the “Group” is operated (set) on the initial setting screen shown in FIG. 6 is determined. If, in step S301, the transmission destination information on the specific transmission method displayed when the address book is opened is determined to be set as the initial settings (if the setting key 180 is operated (set) on the initial setting screen; yes in step S301), when the address book screen is displayed (started up) (when the address book is opened), the transmission destination information (transmission addresses) on the transmission method assigned to the selection key 150 that is initially set is only displayed on the address book screen (step S302).

The narrowing performed with the selection key 150 will now be described. The destination names and the corresponding transmission destination information are stored in the storage portion 13. The details of the initial settings are also stored in the storage portion 13. For example, based on the details of the initial settings, the CPU 11 in the control portion 10 extracts, from the transmission destination information stored in the storage portion 13, the transmission destination information (the transmission destination information on the specific transmission method displayed when the address book is opened) registered on the transmission method corresponding to the selection key 150 specified in the initial settings. Then, the control portion 10 transmits data including the extracted destination names and transmission destination information to the display control portion 42 of the operation panel 40. The display control portion 42 displays, based on the data on the extracted destination names and transmission destination information, the names and the transmission destination information on the address book screen of the operation display portion 41. Thus, the transmission destination information (transmission destination addresses) on the transmission method assigned to the selection key 150 that is initially set is only displayed on the address book screen of the operation display portion 41.

The display control portion 42 receives the data on the destination names and the transmission destination information transmitted from the storage portion 13 and may store, in a nonvolatile manner or in a temporary manner, all or part of the destination names and the transmission destination information and the details of the initial settings (For example, the memory 42a within the display control portion 42 for storing the destination names and the transmission destination information stores them.) Then, when the address book is opened, the display control portion 42 extracts the transmission destination information on the specific transmission method that is initially set, and may display the extracted transmission destination information on the address book screen of the operation display portion 41.

For example, if the setting key 180 of the “FAX” is operated (set) on the initial setting screen (see FIG. 6), as shown in FIG. 13, when the address book screen is started up, the facsimile terminal addresses are only displayed as the transmission destination information (transmission destination addresses). That is, the items to be displayed on the address book screen are narrowed down to the facsimile terminal addresses. Thus, the speed at which the address book is started up (the speed at which the address book is opened) is increased. Here, the selection key 150 of the “FAX” corresponding to the setting key 180 of the “FAX” is brought to a state in which it is highlighted. Thus, it is possible for the user to easily recognize under which condition (on which transmission method) the transmission destination information is displayed. The above-described state is similar to a state in which the selection key 150 corresponding to the operated setting key 180 is operated.

When the highlighted selection key 150 is operated, the operated state of the selection key 150 is cancelled. For example, when the selection key 150 of the “FAX” is operated, the operated state of the selection key 150 of the “FAX” is cancelled. Then, as shown in FIG. 3, the transmission destination information on all the transmission methods is displayed on the address book screen. For example, when another selection key 150 is operated by the user, not only the transmission destination information being displayed but also the transmission destination information (transmission destination addresses) on the transmission method assigned to the operated selection key 150 is displayed on the address book screen. Here, the operated selection key 150 is highlighted.

That is, after the address book screen is displayed, when the selection key 150 is operated, it is possible to select the type of transmission method on the transmission destination information displayed on the address book screen. Even when the selection key 150 is operated, the initial settings are not changed. The process then proceeds to step S306.

On the other hand, if the transmission destination information on the specific transmission method displayed when the address book is opened is determined not to be set as the initial settings (no in step S301), when the address book screen is started up (the address book is opened), all the registered transmission destinations (transmission destination information on all the transmission methods) are displayed. Then, whether or not the selection key 150 is operated by the user is determined (step S303). If the selection key 150 is determined not to be operated (no in step S303), whether or not the selection key 150 is operated is repeatedly determined in step S303. On the other hand, if the selection key 150 is determined to be operated by the user (yes in step S303), the transmission destination information (transmission destination addresses) on the transmission method assigned to the operated selection key 150 is only displayed on the address book screen (step S304). In this case, the narrowing by the transmission method is also preferably performed by the control portion 10 and the display control portion 42.

Then, in step S305, as shown in FIG. 13, the operated selection key 150 is highlighted, and the process proceeds to step S306 of FIG. 12.

Then, whether or not the transmission destination information (transmission destination) is specified is determined (step S306). Specifically, whether or not the check box 111 (see FIG. 3) in the address book screen is checked is determined. If the transmission destination is determined not to be specified (no in step S306), whether or not the transmission destination information (transmission destination) is specified is repeatedly determined in step S306. On the other hand, if the transmission destination information (transmission destination) is determined to be specified (yes in step S306), the transmission destination is set (step S307). Consequently, the operation of setting the transmission destination by selecting the type of transmission destination information (transmission destination addresses) is completed.

When the transmission destination (transmission destination information) is set (specified) through the address book screen, the operations shown in FIG. 7, the operations shown in FIG. 11 and the operations shown in FIG. 12 can be combined together. For example, as shown in FIG. 9, the narrowing keys (the first narrowing key 141 and the second narrowing key 210) are first operated, and thus the names of transmission destinations (destination names) are narrowed with the initial letter thereof. Thereafter, as shown in FIG. 14, the selection key 150 is operated, and thus the type of transmission destination information (transmission destination addresses) displayed can also be narrowed. In this case, the control portion 10 and the display control portion 42 serving as the narrowing processing portion may extract, under the conditions of the second narrowing key 210 and the selection key 150, the transmission destination information stored in the storage portion 13 and the memory 42a. Alternatively, the transmission destination information that has already been held by the display control portion 42 may be further narrowed (extracted) under the condition of the selection key 150.

FIG. 14 shows, as an example, the state in which the selection key 150 of the “FAX” is operated and the facsimile terminal addresses are only displayed. Only the transmission destination information (transmission destination addresses) on the desired transmission method is previously displayed on the address book screen by the operation of the selection key 150. Thereafter, the narrowing keys (the first narrowing key 141 and the second narrowing key 210) are operated, and thus it is also possible to narrow the names of transmission destinations (destination names) with the initial letter thereof. This further enhances the operability of the operation of searching for the transmission destination information (transmission destination address). Moreover, when the transmission destination information on the specific transmission method displayed when the address book is opened is set as the initial settings, the names of transmission destinations (destination names) are thereafter narrowed, with the initial letter, by the operation of the narrowing keys (the first narrowing key 141 and the second narrowing key 210), with the result that the operability of the operation of searching for the transmission destination information (transmission destination addresses) is further enhanced.

Since, as described above, in the multifunction machine 1 of this embodiment, the second narrowing keys 210 for further narrowing the transmission destination information are displayed by detecting that the first narrowing key 141 is operated, it is possible to decrease the number of input keys that are previously displayed on the address book screen. Thus, it is possible to enlarge, in the address book screen, the transmission destination display region 110, on which to display the transmission destination information. Hence, it is possible to increase the number of pieces of transmission destination information displayed on the address book screen. In this way, it is possible to easily enhance the searchability of the desired transmission destination information. Thus, even when the screen size of the operation display portion 41 is relatively small and the display space of the operation display portion 41 is small, it is possible to enhance the operability of the operation of searching for the transmission destination information. Furthermore, even when the number of transmission destinations that can be stored in the address book is increased due to increased memory capacity, it is possible to enhance the searchability of the transmission destination information (claims 1 and 11).

In this embodiment, representative symbols (for example, the digit key 142) of a plurality of symbol groups obtained by grouping are shown on a plurality of first input keys (the first narrowing keys 141), respectively; symbols included in the symbol group corresponding to the first input key are shown on a plurality of second input keys (the second narrowing keys 210), respectively; and the first input key and the second input key (the second narrowing keys 210) are operated such that the operation display portion displays, on the address book screen, transmission destination information obtained by narrowing the transmission destination information with a symbol shown on the operated second input key. In this way, it is possible to easily enhance the operability of the operation of searching for the transmission destination information (claims 2 and 12).

In this embodiment, the transmission destination information is narrowed with the initial letter of the corresponding name. Thus, it is possible to narrow the transmission destination information with the initial letter of the corresponding name (claims 3 and 13).

In this embodiment, groups of letters obtained by grouping letters of an alphabet are shown on the plurality of first input keys (the first narrowing keys 141), respectively; on the plurality of second input keys (the second narrowing keys 210), letters of the alphabet belonging to the corresponding first input key are respectively shown; and the first input key (the first narrowing key 141) and the second input key are operated such that the operation display portion 41 displays, on the address book screen, transmission destination information obtained by narrowing, with a letter shown on the operated second input key, names corresponding to the transmission destination information. Thus, it is possible to narrow the transmission destination information with any one letter of the groups and then it is possible to further narrow the transmission destination information with one of the letters included in the group. Hence, as compared with a case where the transmission destination information is narrowed under the condition of any one of groups, it is possible to narrow the transmission destination information under more specific conditions. In this way, it is possible to enhance the operability of the operation of searching for the transmission destination information, and this allows the desired transmission destination to be easily specified. Even when the size of the operation display portion 41 is relatively small, and, due to the limited space, it is difficult to arrange input keys on the address book screen on an individual alphabetical letter basis, it is possible to narrow the transmission destination information with each of all the letters of the alphabet. In the present invention, the word “shown” means the expression “shown in a recognizable manner”; the word includes the meaning “shown on the input key” and the meaning “shown on a portion other than the input key” (claims 4 and 14).

In this embodiment, when the second input key (the second narrowing key 210) is operated, the display control portion 42 changes a symbol (letter) shown on the corresponding first input key (the first narrowing key 141) to the same symbol as a symbol (letter) that is shown on the operated second input key, and displays the first input key. This makes it easier for the user to recognize under which condition (letter) the transmission destination information is narrowed. Thus, it is possible to easily determine whether or not the narrowing condition is correct, and hence, it is possible to enhance the operability of the operation of searching for the transmission destination information (claims 5 and 15).

In this embodiment, the display control portion 42 changes the display form of the operated first input key (the first narrowing key 141) and displays it such that a difference in visibility between the operated first input key and the other first input keys is increased. This makes it easier for the user to recognize under which condition (symbol) the transmission destination information is narrowed. In the present invention, the expression “change the display form and display” includes the meaning “change at least one of the shape, the size, the design, the color and the font of a symbol and display” (claims 6 and 16).

In this embodiment, the second input keys (the second narrowing keys 210) are displayed by the dialog box 200. In this way, the second input key is selected in an interactive manner, and thus the user can easily perform the narrowing (claims 7 and 17).

In this embodiment, the communication portion 50 can transmit information by a plurality of types of transmission methods, and the operation display portion 41 displays an initial setting screen on which to set the transmission destination information that is first displayed on the address book screen when the address book screen is displayed and that corresponds to a specific transmission method. Thus, when the address book screen is displayed (the address book is opened), the transmission destination information corresponding to the specific transmission method that is initially set is only displayed as the initial state on the address book screen. Specifically, it is possible to narrow the registered transmission destination information down to the transmission destination information corresponding to the desired transmission method and display it, on the address book screen, as the transmission destination information that is first displayed when the address book is opened. Thus, it is possible not only to reduce the number of pieces of transmission destination information that is first displayed but also to increase the speed at which the address book is started up. It is also possible to omit the operation of the selection key 150, and thus it is possible to easily enhance the operability of the operation of searching for the transmission destination information. Even when the number of transmission destinations that can be stored in the address book is increased due to increased memory capacity, it is possible to easily search for the desired transmission destination. Either one or a plurality of transmission methods may be selected (set) as the initial settings. The transmission destination information on the specific transmission method that is initially set is only displayed as the initial state on the address book screen. Thus, it is possible to prevent information from being erroneously transmitted by another transmission method (claims 8 and 18).

In this embodiment, selection keys 150 that are assigned to the types of transmission methods, respectively, and that are used to select the type of transmission method of the transmission destination information are displayed as the input keys on the address book screen, and, when the selection key 150 is operated, the operation display portion 41 displays, along with names on the address book screen, the transmission destination information corresponding to the transmission method assigned to the operated selection key 150. In this way, it is also possible to perform the narrowing with the selection key 150 (claims 9 and 19).

In this embodiment, the display control portion 42 changes the display form of (for example, highlights) the selection key 150 corresponding to the transmission method of the transmission destination information that is initially set or is selected and displays the selection key 150 on the operation display portion 41 such that a difference in visibility between the selection key 150 and the other selection keys 150 is increased. This makes it easier for the user to recognize to which transmission method the displayed transmission destination information (transmission destination addresses) corresponds, and thus it is possible to easily determine whether or not the transmission method is correct. It is therefore possible to enhance the operability of the operation of searching for the transmission destination information. Even if the operated selection key 150 is highlighted, the same benefits as described above can be obtained (claims 10 and 20).

In this embodiment, the operated first narrowing key 141 is highlighted. Thus, it is possible for the user to easily recognize under which condition (letter) the transmission destination information is narrowed.

The embodiment disclosed herein is illustrative in all respects and should not be considered to be restrictive. The scope of the present invention is indicated not by the description of the embodiment discussed above but by the scope of claims, and includes meanings equivalent to the scope of claims and all modifications within the scope of claims.

For example, the above embodiment deals with the case where the present invention is applied to the multifunction machine 1, which is an example of an image forming apparatus. However, the invention is not limited to this case; the invention may be applied to an image forming apparatus other than the multifunction machine 1 as long as the image forming apparatus has a communication function. For example, the invention can be applied to a facsimile machine.

The above embodiment deals with the case where the transmission destinations are narrowed with the alphabet through the first narrowing keys 141 and the second narrowing keys 210. However, the invention is not limited to this case; the transmission destinations may be narrowed with symbols other than the alphabet through the first narrowing keys 141 and the second narrowing keys 210. For example the transmission destinations may be narrowed with Japanese kana characters, Hangul characters, Arabic characters or the like other than the alphabet. The transmission destinations may be narrowed with signs, graphics or the like.

The above embodiment deals with the case where the transmission destinations are narrowed with the initial letter of the destination name through the first narrowing keys 141 and the second narrowing keys 210. However, the transmission destinations may be narrowed with anything other than the destination name.

The above embodiment deals with the case where the operated first narrowing key 141 is highlighted such that a difference in visibility between the operated first narrowing key 141 and the other first narrowing keys 141 is increased. However, the invention is not limited to this case; a method other than that of highlighting the operated first narrowing key 141 may be used such that a difference in visibility between the operated first narrowing key 141 and the other first narrowing keys 141 is increased. For example, the operated first narrowing key 141 may be changed in color, size or shape such that a difference in visibility between the operated first narrowing key 141 and the other first narrowing keys 141 is increased. The font of a letter (symbol) or the like shown may be changed such that a difference in visibility between the operated first narrowing key 141 and the other first narrowing keys 141 is increased (For example, the storage portion 13 stores font data.)

The above embodiment deals with the case where the letters of the alphabet are shown on the first narrowing keys 141 and the second narrowing keys 210. However, the invention is not limited to this case; the letters may be shown on portions other than the first narrowing keys 141 and the second narrowing keys 210.

The above embodiment deals with the case where the selection key 150 corresponding to the transmission method of the transmission destination information that is initially set and the operated selection key 150 are highlighted such that a difference in visibility between the operated selection keys 150 and the other selection keys 150 is increased. However, the invention is not limited to this case; a method other than that of highlighting them may be used such that a difference in visibility between the operated selection keys 150 and the other selection keys 150 is increased. For example, the operated selection keys 150 may be changed in color, size or shape such that a difference in visibility between the operated selection keys 150 and the other selection keys 150 is increased. The font of a letter (symbol) or the like shown may be changed such that a difference in visibility between the operated selection keys 150 and the other selection keys 150 is increased.

The above embodiment deals with the case where the five transmission destination addresses, namely, the facsimile terminal address, the network facsimile terminal address, the e-mail address, the SMB folder address and the FTP folder address, can be registered. However, the invention is not limited to this case; a transmission destination address other than those described above may be registered. The invention may be implemented such that any of the above-described addresses cannot be registered.

A transmission method other than those described in the above embodiment may be used such that data can be transmitted.

In the above embodiment, as long as the operation display portion 41 is a display portion that has a touch panel function, in particular, there is no restriction on how touch detection is performed on the screen of the touch panel. The touch detection on the touch panel may be achieved by a resistive film method, a pressure-detection method (a method of detecting changes in pressure) or an electrostatic method (a method of detecting electrical signals through static electricity), or it may be achieved by any other detection method.

In the above embodiment, the design, layout and the like of the address book screen, the transmission destination registration screen, the initial setting screen and the like can be changed as appropriate.

What is claimed is:

1. An image forming apparatus comprising:
a communication portion for transmitting data;
an operation display portion that displays a plurality of input keys on a screen, that receives an instruction through a key operation and that displays at least an address book screen on which a plurality of first input keys for narrowing transmission destination information are displayed, on which one of the first input keys is operated such that a plurality of second input keys for further narrowing the transmission destination information are displayed, on which one of the displayed second input keys is operated such that the transmission destination information is narrowed and on which to specify a transmission destination displayed along with a name;
a display control portion that controls a display on the operation display portion;
a key operation detection portion that detects a key operation on the input keys including the first input keys and the second input keys; and
a storage portion that stores a plurality of pieces of transmission destination information displayed on the address book screen such that the plurality of pieces of transmission destination information correspond to names, respectively.

2. The image forming apparatus of claim 1,
wherein representative symbols of a plurality of symbol groups obtained by grouping are shown on the plurality of first input keys, respectively; symbols included in one of the symbol groups corresponding to one of the first input keys are shown on the plurality of second input keys, respectively; and the one of the first input keys and one of the second input keys are operated such that the operation display portion displays, on the address book screen, transmission destination information obtained by narrowing the transmission destination information with a symbol shown on the operated second input key.

3. The image forming apparatus of claim 1,
wherein the transmission destination information is narrowed with an initial letter of a corresponding name.

4. The image forming apparatus of claim 1,
wherein groups of letters obtained by grouping letters of an alphabet are shown on the plurality of first input keys, respectively; on the plurality of second input keys, the letters belonging to a corresponding one of the first input keys are respectively shown; and the one of the first input keys and one of the second input keys are operated such that the operation display portion displays, on the address book screen, transmission destination information obtained by narrowing, with a letter shown on the operated second input key, names corresponding to the transmission destination information.

5. The image forming apparatus of claim 1,
wherein, when one of the second input keys is operated, the display control portion changes a symbol shown on a corresponding one of the first input keys to a same symbol as a symbol that is shown on the operated second input key and displays the one of the first input keys.

6. The image forming apparatus of claim 1,
wherein the display control portion changes a display form of an operated one of the first input keys and displays the operated first input key such that a difference in visibility between the operated first input key and the other first input keys is increased.

7. The image forming apparatus of claim 1,
wherein the second input keys are displayed by a dialog box.

8. The image forming apparatus of claim 1,
wherein the communication portion can transmit information by a plurality of types of transmission methods, and the operation display portion displays an initial setting screen on which to set the transmission destination information that is first displayed on the address book screen when the address book screen is displayed and that corresponds to a specific transmission method.

9. The image forming apparatus of claim 8,
wherein selection keys that are assigned to the types of transmission methods, respectively, and that are used to select a type of transmission method of the transmission destination information are displayed as the input keys on the address book screen, and, when one of the selection keys is operated, the operation display portion displays, along with names on the address book screen, the transmission destination information corresponding to one of the transmission methods assigned to the operated selection key.

10. The image forming apparatus of claim 9,
wherein the display control portion changes a display form of one of the selection keys corresponding to one of the transmission methods of the transmission destination information that is initially set or is selected and displays the selection key on the operation display portion such that a difference in visibility between the selection key and the other selection keys is increased.

11. A display method using an operation display portion of an image forming apparatus that includes: a communication portion for transmitting data; an operation display portion that displays a plurality of input keys on a screen, that receives an instruction through a key operation and that displays at least an address book screen on which to specify a transmission destination; a display control portion that controls a display on the operation display portion; a key operation detection portion that detects a key operation on the input keys; and a storage portion that stores a plurality of pieces of transmission destination information displayed on the address book screen such that the plurality of pieces of transmission destination information correspond to names, respectively, the display method comprising:
a step of displaying, on the address book screen, a plurality of first input keys for narrowing transmission destination information;
a step of operating one of the first input keys such that a plurality of second input keys for further narrowing the transmission destination information are displayed; and
a step of operating one of the displayed second input keys such that the transmission destination information is narrowed and resulting transmission destination information is displayed on the address book screen along with a name.

12. The display method using an operation display portion of an image forming apparatus, according to claim 11, the display method further comprising,
a step of: showing representative symbols of a plurality of symbol groups obtained by grouping on the plurality of first input keys, respectively; showing symbols included in one of the symbol groups corresponding to one of the first input keys on the plurality of second input keys, respectively; and operating the one of the first input keys and one of the second input keys so as to display, on the address book screen, transmission destination information obtained by narrowing the transmission destination information with a symbol shown on the operated second input key.

13. The display method using an operation display portion of an image forming apparatus, according to claim 11,
wherein the transmission destination information is narrowed with an initial letter of a corresponding name.

14. The display method using an operation display portion of an image forming apparatus, according to claim 11, the display method further comprising,
a step of: showing groups of letters obtained by grouping letters of an alphabet on the plurality of first input keys, respectively; showing, on the plurality of second input keys, the letters, respectively, belonging to a corresponding one of the first input keys; and operating the one of the first input keys and one of the second input keys so as to display, on the address book screen, transmission destination information obtained by narrowing, with a letter shown on the operated second input key, names corresponding to the transmission destination information.

15. The display method using an operation display portion of an image forming apparatus, according to claim 11, the display method further comprising,
a step in which, when one of the second input keys is operated, the display control portion changes a symbol shown on a corresponding one of the first input keys to a same symbol as a symbol that is shown on the operated second input key and displays the one of the first input keys.

16. The display method using an operation display portion of an image forming apparatus, according to claim 11, the display method further comprising,
a step in which the display control portion changes a display form of an operated one of the first input keys and displays the operated first input key such that a difference in visibility between the operated first input key and the other first input keys is increased.

17. The display method using an operation display portion of an image forming apparatus, according to claim 11,
wherein the second input keys are displayed by a dialog box.

18. The display method using an operation display portion of an image forming apparatus, according to claim 11,
wherein the communication portion can transmit information by a plurality of types of transmission methods, and the display method further comprises a step in which the operation display portion displays an initial setting screen on which to set the transmission destination information that is first displayed on the address book screen when the address book screen is displayed and that corresponds to a specific transmission method.

19. The display method using an operation display portion of an image forming apparatus, according to claim 18, the display method further comprising,
a step in which selection keys that are assigned to the types of transmission methods, respectively, and that are used to select a type of transmission method of the transmission destination information are displayed as the input keys on the address book screen, and, when one of the selection keys is operated, the operation display portion displays, along with names on the address book screen, the transmission destination information corresponding to one of the transmission methods assigned to the operated selection key.

20. The display method using an operation display portion of an image forming apparatus, according to claim 19, the display method further comprising,
a step in which the display control portion changes a display form of one of the selection keys corresponding to one of the transmission methods of the transmission destination information that is initially set or is selected and displays the selection key on the operation display portion such that a difference in visibility between the selection key and the other selection keys is increased.
